(19) United States
(12) Patent Application Publication
(10) Pub. No.: US 2014/0196144 A1
(43) Pub. Date: Jul. 10, 2014

(54) Method and Apparatus for Detecting Malicious Websites

(71) Applicant: Jason Aaron Trost, Atlanta, GA (US)

(72) Inventor: Jason Aaron Trost, Atlanta, GA (US)

(21) Appl. No.: 13/734,904

(22) Filed: Jan. 4, 2013

(51) Int. Cl. H04L 29/06

(52) U.S. Cl. CPC H04L 63/14
USPC 726/22

(57) ABSTRACT

A method and apparatus for detecting malicious websites is disclosed.

### BACKGROUND OF THE INVENTION

Internet traffic and the number of web servers and websites continues to grow at an enormous rate. At the same time, malicious websites are becoming an increasingly serious problem. Users often are provided with URLs to such websites in unsolicited emails, SMS or MMS messages, or other communications. If a user then visits the website using that URL, the website can harm the user or his or her computer in a multitude of different ways, including loading malware onto the user's computer or gathering sensitive data from the user's computer. For example, a malicious website can load a harmful virus or worm onto the user's computer as soon as the computer accesses the website.

There are existing methods for warning users about malicious websites. For example, a user can install security software onto his or her computers that will produce a warning message if the user attempts to visit a website that is a known malicious website. This type of software is dependent upon databases or lists of known malicious websites and requires that the database or list be constantly updated. These methods are effective for avoiding malicious websites that are already known. However, they provide no protection against new malicious websites that have not yet been added to the database or list.

What is needed is a method and apparatus for identifying malicious websites with a high probability, even if the website is new and not a known malicious website.

What is further needed is a method and apparatus for identifying malicious websites on an extremely large scale, as might be required for an Internet Service Provider or corporate network server that wishes to protect all of its end users from visiting malicious websites.

### SUMMARY OF THE INVENTION

The aforementioned problems and needs are addressed by a method and apparatus for analyzing a URL and predicting whether the URL corresponds to a malicious website.

### BRIEF DESCRIPTION OF THE DRAWINGS

FIG. 1 is an exemplary block diagram of a prior art system for accessing a website.

FIG. 2 is an exemplary flowchart of a prior art method of accessing a malicious website.

FIG. 3 is an exemplary block diagram of an embodiment of a domain classification engine.

FIG. 4 is an exemplary flowchart of the operation of an embodiment of a domain classification engine.

FIG. 5 is an exemplary flowchart depicting the internal operation of an embodiment of a domain classification engine.

FIG. 6 is a depiction of an exemplary domain name used in conjunction with the embodiments.

### DETAILED DESCRIPTION OF THE PREFERRED EMBODIMENTS

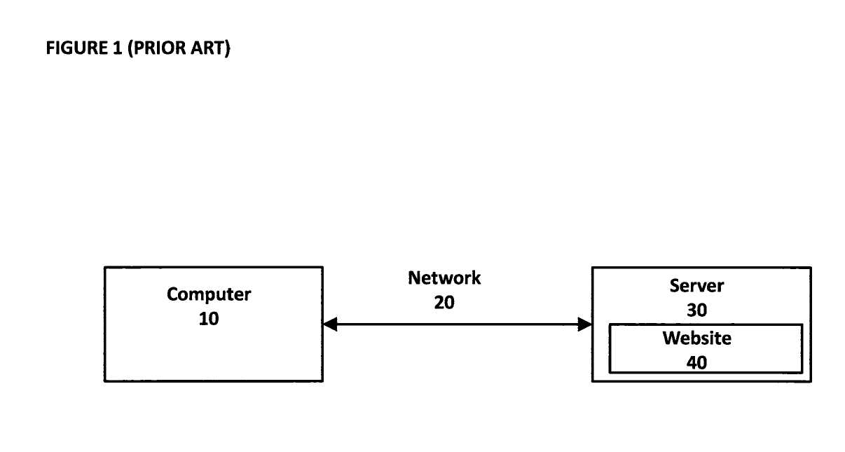

A prior art system is depicted in FIG. 1. A user operates computer 10. Computer 10 can be a desktop, notebook, mobile device, touchpad, or any other computing device. Computer 10 accesses server 30 over network 20. Network 20 can be a wired network, a wireless network, or a combination of the two. Server 30 also is a computer, and can be a desktop, notebook, mobile device, touchpad, or any other computing device. Server 30 operates website 40 and allows computer 10 to access website 40 using a browser or similar software. Computer 10 and server 30 communicate over network 20 using HTTP or other known protocols.

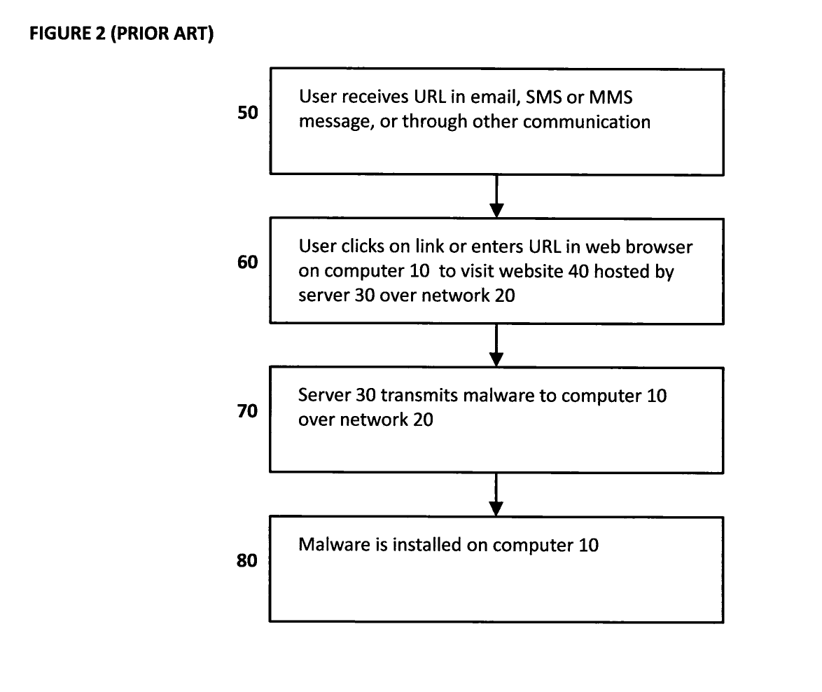

With reference now to FIG. 2, a prior art method involving a malicious website is described using the components of FIG. 1. First, a user receives a URL in an email, SMS or MMS message, or through other communication (step 50). Second, the user clicks on the link or enters the URL in a browser on computer 10 to visit website 40 (designated by the URL) hosted by server 30 using network 20 (step 60). Third, server 30 transmits malware to computer 10 over network 20 (step 70). Fourth, the malware is installed on computer 10 (step 80), which damages computer 10 and/or the user's data stored on computer 10.

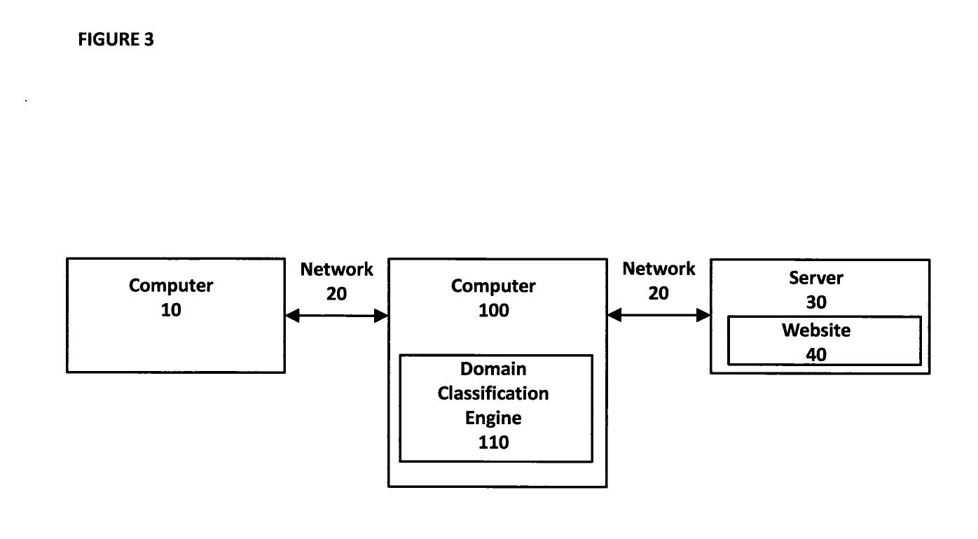

An embodiment is now described with reference to FIG. 3. In this embodiment, all web access by computer 10 is routed through computer 100, as would be the case, for example, if computer 100 is an Internet Service Provider used by computer 10, or computer 100 is a network server utilized by computer 10 (such as within a corporation). Computer 100 comprises domain classification engine 110, which is software running on computer 100. Any attempted access by computer 10 to server 30 or website 40 is routed through computer 100.

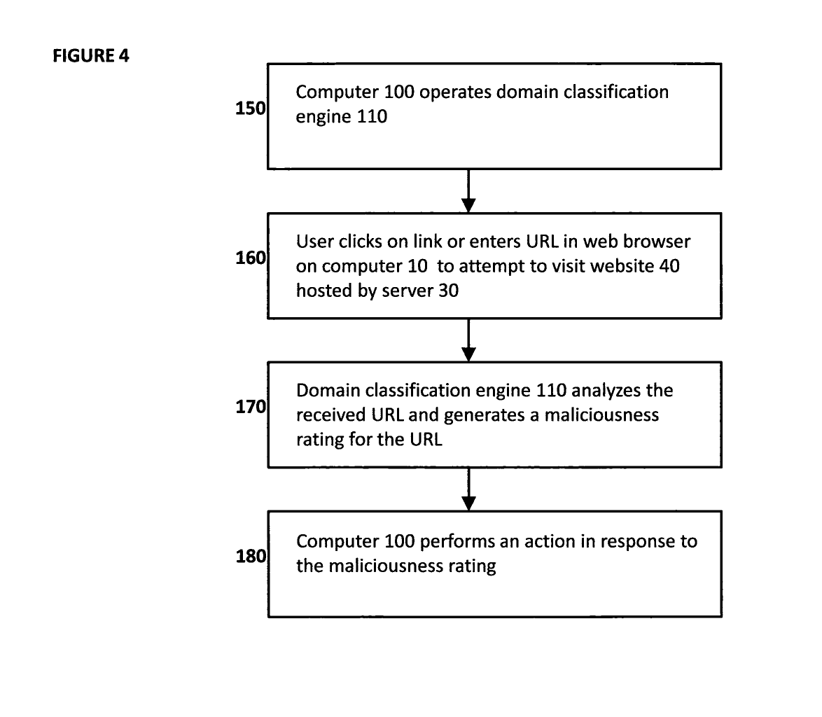

The embodiment is further described in FIG. 4. Computer 100 operates domain classification engine 110 (step 150). A user clicks on a link or enters a URL in a web browser on computer 10 to attempt to visit website 40 hosted by server 30 (step 160). Domain classification engine 110 analyzes the received URL and generates a maliciousness rating for the underlying domain name (step 170). Computer 100 performs an action in response to the maliciousness rating (step 180). Such action can include: preventing access by computer 10 to website 40 or server 30; allowing access by computer 10 to website 40 or server 30; sending a message to computer 100; or generating an alert for a user of computer 10 or the operator of computer 100. As can be seen in FIGS. 3 and 4, this embodiment can prevent the installation of malware on computer 10, in contrast with the prior art system of FIGS. 1 and 2.

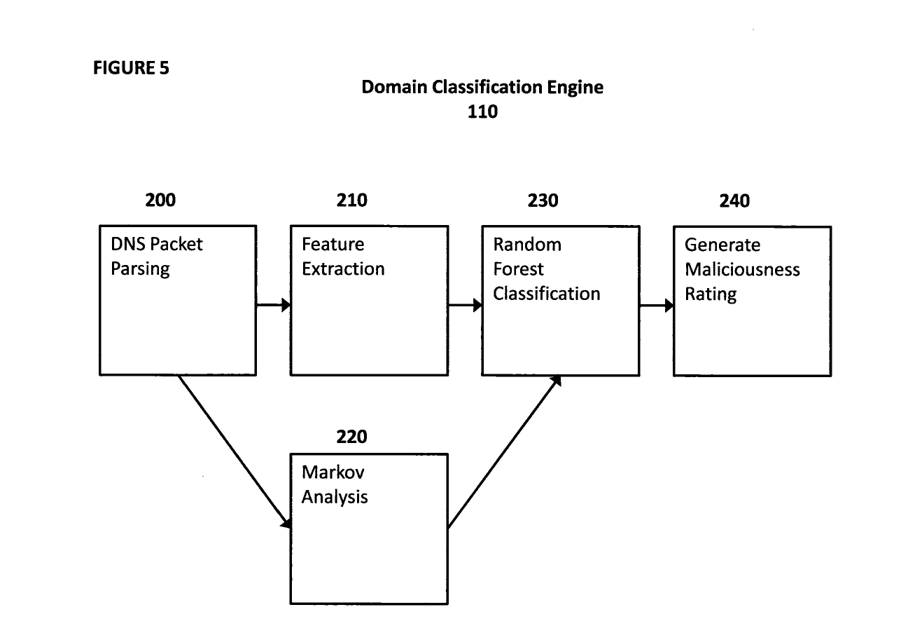

Additional description will now be provided of domain classification engine 110. The internal operation of an embodiment of domain classification engine 110 is shown in FIG. 5. Domain classification engine 110 first receives a DNS request (as would occur when a computer attempts to access a URL) and performs DNS packet parsing (step 200). DNS packet parsing involves receiving a URL and determining certain characteristics of the domain name of the URL, such as the number of digits, number of vowels, number of consonants, percentage of characters that are repeated, number of digits that appear consecutively, and number of consonants that appear consecutively.

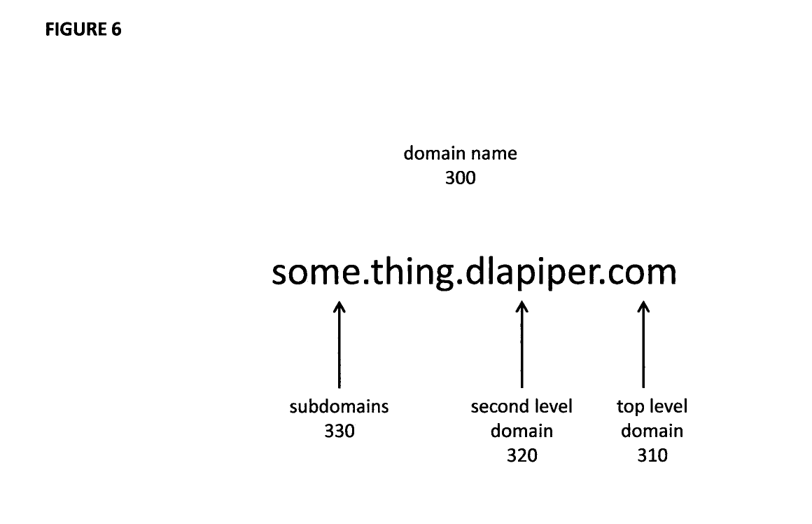

An example of a domain name 300 is shown in FIG. 6. In this example, domain name 300 comprises a top-level domain 310 (“.com”), a second-level domain (“dlapiper”), and a plurality of subdomains 320 (“some” and “thing”). The left-most subdomain is sometimes referred to as the “high level domain” (here, “some”). A URL comprises a domain name and also can include other data, such as “http” and “www”.

With reference again to FIG. 5, domain classification engine 110 then performs feature extraction (step 210). Feature extraction involves generating a value for each of a plurality of features, each of which tends to correlate with the maliciousness of a URL. Examples of features are shown in Table 1:

TABLE 1
EXEMPLARY FEATURES FOR FEATURE EXTRACTION

% of longest consecutive digits in high level domain
% of longest consecutive consonants in subdomains
% of longest consecutive digits in subdomains
% of longest consecutive vowels in subdomains
% of longest consecutive consonants in high level domain
% of longest consecutive vowels in high level domain
% of longest repeated characters in subdomains
# of domain levels
% of vowels in subdomains
% of longest repeated characters in high level domain
Top level domain
Randomness Score
% of digits in subdomains
Length of full domain
% of digits in 2LD
% of LRC in 2LD
% of vowels in HLD
% of longest consecutive vowels in 2LD
% of vowels in 2LD
% of digits in HLD
% of longest consecutive consonants in 2LD
% of longest consecutive digits in 2LD
RFC compliance

In parallel with feature extraction 210, domain classification engine 110 also performs Markov analysis (step 220). Markov analysis is a known method in the field of statistics a probability for an event is determined based on the probability of its sub-events. As applied in this embodiment, domain classification engine 110 determines the probability of a digit occurring in normal language (such as English) given the preceding two (or other number) digits. For example, if the received URL is google.com, domain classification engine will determine the probability of a “g” occurring at the beginning of a word, the probability of an “o” occurring after a “g,” the probability of an “o” occurring after a “g” and “o,” the probability of a “g” occurring after an “o” and “o,” and so forth. In this manner, domain classification engine 110 determines a probability for each digit. It them multiplies the probability for each digit to obtain a probability for the entire domain name. This can be referred to as the Markov Probability for the domain name and indicates the randomness of the domain name. The probabilities for each digit can be determined based on a database of existing usage, such as a dictionary, or a list of known, good (non-malicious) domain names. This Markov analysis takes advantage of the fact that malicious domain names often look like “gibberish” and do not make sense in everyday English or other spoken language.

Domain classification engine 230 then performs random forest classification (step 230). Random forest classification is a known method in the field of statistics whereby a classification is made of an input based upon an existing dataset. Here, random forest classification can comprise classifying a domain name as malicious based on a dataset of known malicious domain names. Random forest classification also can comprise classifying a domain name as good (non-malicious) based on a dataset of known good (non-malicious) domain names.

Domain classification engine 230 then generates a maliciousness rating (step 240) based on the results of the Markov analysis (step 220), feature extraction (step 210), and random forest classification (step 230). The maliciousness rating will indicate the likelihood that the domain name corresponds to a malicious website. A threshold can be chosen (e.g., 0.60 on a scale of 0 to 1.00) that is used to determine whether a website is malicious or not.

In response to a high maliciousness rating (indicating a high likelihood that the website is malicious), computer 100 can take any number of different actions, such as preventing access by computer 10 (or a plurality of computers) to website 40 or server 30; sending a message to computer 100; generating an alert for a user of computer 10 or the operator of computer 100, updating a list or database of known malicious websites or known good websites; or generating a user interface for an operator of computer 100 or a user of computer 10 that provides the maliciousness rating or data reflective of that rating (such as a graph). These actions optionally can be performed by an execution engine 120 (not shown), which is software running on computer 100.

The database or list of known malicious websites or known good websites can be continually updated. Thereafter, the probabilities for the Markov analysis can be updated, as can the models for the random forest classification. Thus, the quality of the predictions made by the embodiments as to whether a domain name corresponds to a malicious website or a good website will remain high even as the operators of malicious website change their strategies in selecting domain names.

In another application of the embodiments, domain classification engine 230 can be used to identify computers that already have been infected by malware. It is a common practice for malware to cause the infected computer to perform a DNS lookup on a domain name that the malware attacker controls. The infected computer will then obtain the IP address for that domain name and will be directed to a server at that IP address. The server will be controlled by the malware attacker, and the server will provide commands and/or instructions to the infected computer. Domain classification engine 230 can be used to analyze the domain names during the DNS lookup events and can generates a maliciousness rating for the domain names using the same methods and apparatuses discussed previously. If the maliciousness rating indicates a malicious domain name, then the same type of actions described previously can be taken (e.g., adding the domain to a list of known malicious websites), and in addition, an operator can be notified that the computer that initiated the DNS lookup likely has been affected with malware.

The embodiments described herein are valuable in detecting domain names, even if not yet known, of malicious websites. The embodiments also are very scalable and can be used in environments involving a large number of DNS requests, as is the case with ISPs or corporate network servers.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims.

What is claimed is:

1. A system for processing data received over a network, comprising:
a computing device for receiving a first set of data over a network;
a storage device coupled to the computing device for storing at least a portion of the first set of data;
wherein the computing device comprises a filtering engine for filtering the first set of data to create a second set of data and an aggregation engine for augmenting the second set of data to create a third set of data; and
wherein the computing device is further configured to provide all or a portion of the third set of data to a client computer.

2. The system of claim 1, wherein the network is the Internet.

3. The system of claim I, wherein the data originates from a sensor on the network.

4. The system of claim 1, wherein the data comprises Domain Name Service data.

5. The system of claim 4, wherein the data further comprises IP address data.

6. A system for generating an improved user interface, comprising:
a computing device comprising a video screen, wherein the computing device is configured to generate a user interface on the video screen;
wherein the user interface comprises a plurality of facets, each facet containing a plurality of selectable items; and
wherein at least one of the plurality of facets is updated in real-time by the computing device.

7. The system of claim 6, wherein the user interface comprises a map.

8. The system of claim 6, wherein the content of at least one facet is configured to change in response to the selection of an item on another facet.

9. The system of claim 7, wherein data is displayed on the map.

10. The system of claim 9, wherein the data changes in real-time.

11. A method for processing data received over a network, comprising:
receiving, by a computing device, a first set of data over a network;
storing, by a storage device coupled to the computing device, at least a portion of the first set of data;
filtering, by a filtering engine in the computing device, the first set of data to create a second set of data;
augmenting, by an aggregation engine in the computing device, the second set of data to create a third set of data; and
providing, by the computing device, all or a portion of the third set of data to a client computer.

12. The method of claim 11, wherein the network is the Internet.

13. The method of claim 11, wherein the data originates from a sensor on the network.

14. The method of claim 11, wherein the data comprises Domain Name Service data.

15. The method of claim 14, wherein the data further comprises IP address data.

16. A method for generating an improved user interface, comprising:
generating, on the video screen of a computing device, a user interface;
wherein the user interface comprises a plurality of facets, each facet containing a plurality of selectable items; and
updating, by the computing device, in real-time at least one of the plurality of facets.

17. The method of claim 16, further comprising the step of displaying a map in the user interface.

18. The method of claim 16, further comprising the step of changing the content of at least one facet in response to the selection of an item on another facet.

19. The method of claim 17, further comprising displaying data within the map.

20. The method of claim 19, further comprising the step of changing the data in real-time.
